(19) United States
(12) Patent Application Publication
(10) Pub. No.: US 2009/0094601 A1
(43) Pub. Date: Apr. 9, 2009

(54) METHOD AND DEVICE FOR PROTECTING SOFTWARE FROM UNAUTHORIZED USE

(76) Inventors: Vladimir Nikitich VSTOVSKIY, St. Petersburg (RU); Dmitry Igorevich Goryunov, St. Petersburg (RU); Mikhail Fedorovich Akhramenko, St. Petersburg (RU)

Correspondence Address: Maria NILOVA;PATENTICA LLC, Office 303, 51 Sadovaya Street, Saint Petersburg, 190068, RU

(21) Appl. No.: 12/258,684

(22) Filed: Oct. 27, 2008

Related U.S. Application Data
(63) Continuation-in-part of application No. PCT/RU2007/000219, filed on Apr. 26, 2006.

(30) Foreign Application Priority Data
Apr. 27, 2006 (RU) 2006114101

(51) Int. Cl. G06F 9/445; G06F 12/02

(52) U.S. Cl. 717/177; 711/103; 711/E12.008

(57) ABSTRACT

The present invention relation to a method and device for protecting a software program from unauthorized use, comprising a processor, a non-volatile memory, a content protection means, and a communication interface, wherein the non-volatile memory records and stores at least one functional fragment extracted from the said software program, wherein at least one transfer function is embedded into the remaining part of the software program for sending to the software protection device initial data and/or commands initiating execution of the extracted fragment to produce result data, and sending the result data to the programmable computer device, thus preventing hacking of the said software program. The software protection device can be implemented as an external or internal computer module.

### BACKGROUND OF THE INVENTION

1. Field of the Invention

The present invention relates to the field of software protection and can be used by program manufactures and retailers to protect the software installed on computers, controllers and other programmable computer devices from unauthorized use, copying, replication, modification, distribution and investigation.

2. Description of Related Art

The software industry has been aware for some time of the problem of unauthorized use and distribution of software and other digital content. Large amounts of income are lost each day due to unauthorized copying and distribution of software, so-called software piracy. According to BSA (Business Software Alliance) more than 38% of all software in use is illegally copied, worldwide. In 1998, software piracy cost the software industry $11 billion in lost revenue, in 2003, $29 billion, and in 2005, $34 billion. Due to loss revenue, there are fewer jobs, less innovations, and higher costs for consumers.

In particular, this relates to the Internet worldwide network, as well as other data communication networks, which enables many PEC, including personal computers, laptops, tablet computers, PDAs, gaming consoles, etc, to interconnect and exchange information. A particular use of the Internet, and other networks such as cable and satellite or a corporate or organization network is to distribute software programs. However, this distribution often takes the form of illegal downloading and sharing of copyrighted software by parties that are not licensed to do so.

In order to combat illegal distribution of copyrighted software, and to enforce use of digital content according to license, various protection methods are employed by software manufactures and retailers.

A well-known solution to software protection is the Product Activation, or password protection, based on using key words (activation codes). Product Activation, also known as Software Activation, is a unique business model used in the majority of commercially available software (e.g. Adobe Illustrator™ by Adobe Systems Inc.), SCO Open Server™ by Santa Cruz Operation Ltd., and other software and providing more control over how a software application is distributed and used.

In general, it provides software protection by limiting the number of times software can be installed. Typically, the objective of software activation is to allow installation of a software application on a single machine. Within a predetermined period after the installation (e.g. the first 30 days), the user must get the system “activated”, and only then he can use it. Activation involves communication between the machine on which the software application has been installed and a licensing server, typically over the Internet, and includes providing information about the hardware on which the application is installed. Assuming the software has been purchased legally, the remote server provides a release code to be recorded on the user's system. Each time the software application is invoked the code is checked against the hardware components of the machine (e.g. the type of display adapter, SCSI adapter, IDE Adapter, processor type, etc.) and execution is allowed only if the code corresponds to the expected one.

Since the product activation solution is tied to the user's hardware, any change in the user's hardware creates an obstacle to the ability to positively identify the user's machine. Replacing one machine by another requires the user to re-activate the software. Moreover, executing a licensed software application on more than one machine creates an additional obstacle.

The password protection of software is the simplest one of the above, although it offers lowest protection due to its inability to prevent unauthorized distribution by registered users as they already know the password (activation code)—nor does it prevent activation code transfer to unregistered users and further unauthorized use and/or distribution of software.

The passwords (activation codes) for the majority of known software products are available on the Internet enabling unauthorized use and/or distribution of software using non-licensed copies thereof.

Passwords (activation codes) can be analyzed and picked by means of software disassemblers such as IDA (static analysis methods) and debuggers such as SoftICE (dynamic analysis methods) applied by users of average and advance skill to identify know-how and/or confidential information. This software can also be used to identify and eliminate the password or activation code checking functions from the software enabling unauthorized use and/or distribution of software in defiance of password and/or activation code.

Another approach for software protection is based on a Local Licensing Server, i.e. a server that operates at an organization's private network and controls the licensing/protection functionality of one or more software products. For example, a local licensing server is provided with a pool of N licenses, i.e. no more than N copies of the program are allowed to be used at the same time. Each time a copy of the software is activated, the software “asks” the licensing server for permission to run. Each time a user runs the software application by a user, the licensing pool is decremented by one, and each time a user finishes working with the application, the licensing pool is incremented by one. In case where more than N users use the application at the same time, the server can refuse to enable additional licenses, charge the organization for extra use, etc., according to the licensing terms purchased by the organization.

The software protection based on registration data input and interaction with the software supplier does not require any hardware protection although it can only prevent unauthorized distribution and use of software by registered and unregistered users of low and average skill.

Despite continuous monitoring of software distribution (i.e. each replication instance unlike single-time password protection) this method is vulnerable to static and dynamic analysis since the information contained in the registration data entered for communication with the software supplier is sent to the PEC memory via the data link thus creating the risk of replication and further use by unauthorized users.

Currently, the most reliable in terms of preventing unauthorized activities of registered and unregistered users are DRM systems based on the use of key media, e.g. magnetic cards, such as produced by OMRON Electronics Ltd., magnetic media with defects, intellectual electronic keys based on microprocessors and memory chips (Touch-Memory electronic identification devices, HASP hardware keys by Aladdin Knowledge Systems Ltd, which interact with digital content, e.g. software program, at the hardware level, e.g. via magnetic card readers, Touch-Memory readers or I/O computer ports.

Thus, the HASP™ is a family of products for protecting software applications (i.e. preventing its piracy) and also for Digital Right Management (DRM). The HASP family currently includes the following products: HASP HL™, which is a hardware-based licensing and software protection system; Privilege™, which is a software-based licensing, software protection and software distribution system; Privilege Trialware Toolkit, for creating secure, controlled software trialware; and HASP DocSeal™, which is a hardware-based system for protection of intellectual property and sensitive information in your HTML files.

The operation of software protected by means of hardware keys plugged into an I/O port of the PEC requires key identification (i.e. a key code is queried and compared against the one stored in the program). Based on identification result, the software follows a pre-determined operation protocol.

For example, the HASP HL™ is distributed in the form of a token (also known as “dongle”) to be inserted into a USB port, or similar port (e.g. parallel port) of a computer. It is a hardware-based encryption engine used for encrypting and decrypting data for software protection. During runtime the HASP HL™ receives encrypted strings from the protected application and decrypts them in a way that cannot be imitated. The decrypted data that is returned from the HASP HL™ is employed by the protected application so that it affects the mode in which the program executes: it may load and run, it may execute only certain components, or it may not execute at all. The on-chip encryption engine of HASP™ employs a 128-bit AES Encryption Algorithm, Universal API, single license capacity, cross-platform USB, and more.

Though electronic key protection is more reliable so far, it is implemented as an auxiliary device (i.e. a key) having a unique code recorded therein, and therefore, there is a possibility of revealing this code stored in the key or in the program itself using same static and dynamic analysis software as mentioned above (i.e. disassemblers and debuggers). From this point of view, intellectual processor-based keys which implement complex secure protocols of key media interaction with the protected software application are less susceptible to attacks. In particular, these means for software protection comprise supplying with the licensed software a key with software fragments intentionally removed from the external media and embedded in a hidden form into the memory of the key. As the software is run, the missing fragments are read from the key memory into the system memory, decoded and executed. Using key media with unique codes ensures copy protection of software and/or prevents its unauthorized distribution by both authorized and unauthorized users of low and average skill.

However, this kind of protection is still vulnerable to analysis by means of debuggers, hardware emulators of computer environment, and analysis of protocols of key media interaction with the software using measuring equipment—i.e. logic analyzers such as HP 54620A, HP 54620C, and HP 1664A by Hewlett Packard. For example, software debuggers track and trap the digital content information after the rendering application has decrypted it, retrieving the “protected” information. Such information includes the digital content file and metadata describing how it is to be rendered. A hacking program that cracks the application and releases this information from the DRM system enables the construction of unauthorized copies of the original digital content file. Thus, highly skilled registered users can still identify the know-how or confidential information contained in the software by using disassemblers. The same methods can be applied to determine and eliminate the key media checking regions from the software to enable subsequent unauthorized use and/or distribution of software in defiance of key media. The problem is exacerbated by the fact that many of the more significant tools used for subversion are powerful and legitimate tools commonly used in the software and hardware development industry; for example In Circuit Emulation (ICE) tools, debugger tools, and disassembly tools. Such tools are legal to own, easy to obtain, and continue to become more advanced and effective. Examples of these widely known and deployed tools include SoftIce, available from NuMega, any of the debuggers available from Microsoft or Borland, the powerful protection-removal tool ProcDump, a shareware tool available free by download on the Internet, and many others.

As a countermeasure, DRM systems can use more sophisticated cryptographic schemes and code obfuscation techniques. Other methods include adding tamper resistant hardware to store the cryptographic keys. Examples of such methods are cryptographic tokens such as described in U.S. Pat. No. 7,131,006 to Verizon Laboratories Inc or using a smart card to store cryptographic keys and optionally cryptographic algorithms, such as described in U.S. Pat. No. 7,165,727 to Sun Microsystems. Such solutions either reveal the cryptographic key to the digital appliance in the process of decrypting the information, or internally perform the cryptographic functions but reveal the end result in a raw form that can then be accessed.

Such methods require the appliance to include an implementation of cryptographic algorithms and hold cryptographic keys in order to gain access to the content; therefore the cryptographic methods and keys must reside within the reach of the application. All the above requirements cause unnecessary software complexity and reduce its operation speed and functional reliability.

Furthermore, the above methods have proven to slow, but not halt, an adversary. Given enough time and effort, a computer program that cracks a DRM system may be written. It can be appreciated by those skilled in the art that such successful attacks are easier to carry out on software applications that execute in an open development environment that enables programmers to develop software programs. Similarly, cryptographic co-processors leave the content vulnerable after decryption.

Thus, another common problem of the above described software protection methods is that the protected software including the security solutions sooner or later enters the PEC data link and memory as required for processing and execution by the PEC processor. From this point on, the software can become vulnerable to copying, replication and intrusion by both authorized and unauthorized software users.

This means that any sufficiently skilled software user, with the appropriate effort, time and resources, can block the verification functions of known security solutions or assemble the missing code fragments required for recreation, use and distribution of copies of the main code by using known desassemblers and debuggers rendering the software protection useless.

A method of protecting a digital content, described in US Patent Application US20060010500, includes separating the original copyrighted digital content to produce two or more parts such that each one separately is not sufficient for end use of the copyrighted digital content. The two resulting processed files are recombined into a unified file which is compressed and encrypted in order to be distributed over a network. The received unified file is stored in the DRM device, which at the appropriate time, sends one file to the user computer for processing and processes the second file internally in the DRM device. However, the results of processing can combined in the digital appliance and hence, become vulnerable to illegal copying.

According to alternative solution described in US20060242082, the second part is stored and executed in a remote server. At no point during this process is the complete set of original content available on the digital appliance nor is the complete set of processing algorithms used to produce the useable content available on the digital appliance, hence open for the possibility of hacking. However, as the second part is stored in a remote server in a computer readable form, it can be illegally copied from the server.

Furthermore, the methods involving complex encryption algorithms make the programs bulky and slow up downloading of the files from the network.

Thus, there is a need for a method and means of software protection that avoid the above described problems of the prior art and provide easy and efficient whilst completely secure distribution and use of software programs.

### BRIEF SUMMARY OF THE INVENTION

The object of the present invention is to provide a reliable software protection from unauthorized use, replication, distribution, investigation and modification that would protect from all known methods of illegal copying and reproduction of software.

Another object is to provide a software protection method and device that would be resistant to static and dynamic investigation by means of disassembling and debugging programs and hardware means of intrusion.

Still another object of the invention is to provide a software protection method and device that would prevent from obtaining a fully functional software copy on any known media, such as a memory of a programmable computer device running the software.

Another object of the invention is to provide an easy tool for software manufactures and distributors allowing for simple, reliable and efficient software protection eliminating the need for encryption and decryption, creation, verification, and use of unique key media or security codes.

Still another object of the invention is to reduce or substantially eliminate the risk of recreating the original code stored in the memory of a legally produced software protection devices even in case of illegal reproduction or creation of an identical hardware copy thereof, so as to completely prevent from unauthorized use, copying, distribution and investigation of software protected by means and methods in accordance with the present invention.

This and other objects are achieved by providing a software protection device for protecting a software program from unauthorized use, comprising:

a non-volatile memory for recording and storing at least one functional fragment extracted from the said software program,

a content protection means for protecting at least part of the content of the said non-volatile memory, the protected part storing the said at least one functional fragment extracted from the said software program;

a communication interface for data communication with a programmable computer device, and

a processor for processing the extracted functional software fragment stored in the said non-volatile memory,

wherein the said software protection device is connectable to a programmable computer device for communicating data to enable execution of the remaining part of the software program.

According to the invention, communicating data includes sending initial data and/or commands from a programmable computer device to initiate execution of the extracted fragment in the software protection device to produce result data, and sending the result data to the said programmable computer device

According to the invention, a content protection means protects from copying, reading, replication, investigation, modification and/or deletion.

A content protection means can be implemented in software, hardware or firmware.

According to the invention, the content protection means can be multilevel, i.e. it can provide different kinds of protection applied step-wise.

For example, in one embodiment, the software protection device can be manufactured with a read-proof non-volatile memory, which can be used for recording and storing any part or a complete software program which, once it is written into the memory, cannot be read out.

According to another embodiment, the content protection means can further provide additional protection activated after the content is written into the memory, to provide the content, once it is written into the memory, cannot be further modified or deleted in any way and/or no any additional content cannot be written into the same non-volatile memory. This protective shield can be implemented, e.g. by password protection, or other appropriate means as can be defined by a specialist in the art.

According to another embodiment, a further protective shield can be applied to protect the password from password screening methods. Available methods can be defined by a specialist in the art.

According to a still further embodiment, a final shield can be applied to lock the memory completely.

A particular type of protection can be selected by a specialist in the art depending on the specific conditions and security requirements and applied using the conventional tools.

For example, the protection can be implemented using “program and data memory lock bits” as described in Atmel publications, see e.g. http://www.atmel.com/dyn/resources/prod_documents/doc2486.pdf. Any other suitable content protection can be used according to the invention.

According to the invention, preferably, the said at least one functional fragment extracted from the said software program is stored in the said non-volatile memory in machine readable form, e.g. in the form executable by a processor of the software protection device.

Alternatively, the said at least one functional fragment extracted from the said software program can be stored in the memory of the software protection device in the form executable by another processor, e.g. using virtual machine emulation. Using virtual machine emulation allows executing codes which were originally complied for other types of processors. Alternatively, is possible to execute text instructions, using Java virtual machine, or the like.

According to one embodiment, the said at least one extracted fragment is stored in the part of the non-volatile memory which is protected by the content protection means.

According to one embodiment, the remaining part of the software program lacking at least one functional fragment is stored in the part of the non-volatile memory which is not necessary protected by content protection means.

Alternatively, the remaining part of the software program lacking at least one functional fragment can be stored in additional non-volatile memory, which is not protected by content protection means or protected by content protection means.

According to one more alternative, the remaining part of the software program lacking at least one functional fragment is downloadable from a remote server or network.

According to one more alternative, the remaining part of the software program lacking at least one functional fragment can be stored on any suitable computer readable carrier, e.g. a CD, flash memory, and the like.

Further, as shall be obvious for a specialist in the art, the said processor, a non-volatile memory and a communication interface are connected with each other by communication means.

According to one embodiment of the invention, a software protection device can be implemented in the form of an external module, such as a firmware module.

According to another embodiment, a software protection device can be implemented in the form of an internal module, and used e.g. for securing system software, such as BIOS, and the like.

For example, the software protection device according to the invention can be implemented as a circuit board or microchip that can be connected to the ports or buses of a programmable computer device, such as a PC, controller, laptop, PDA, or any other programmable computer devices by means of a communication interface, or can be implemented a circuit board with a programmable microchip, programmable controller or programmable logic device (PLD) that can be integrated into a programmable computer device. One of the possible implementation includes C8051F320/1 microcontroller produced by Silicon Laboratories which contain a processor core, programmable Flash-memory and a hardware means of protection from reading, replication or modification of the programs or data stored therein.

The software protection device further includes a random access memory (RAM) for storing variables and performing the function of stack data or data exchange buffer required for processor operation. The random access memory can be connected to the processor e.g. via data link and connected to a programmable computer device by means of communication interface.

The communication interface can be implemented in the form of a physical link or wireless, e.g. using USB, PCI, RS-232, COM, LPT, Ethernet, Bluetooth or IRDA.

According to the invention, the software protection means can further comprise an additional interface for programming the said non-volatile programmable memory. In one embodiment, the said additional programming interface can be optionally integrated with the communication interface.

According to still another embodiment, the content protection means at least partially or completely blocks access to the non-volatile memory via the programming interface and/or processor. In another embodiment, or in addition, the said content protection means can switch off the programming interface completely.

According to the invention, the said means for protecting the content of the said non-volatile memory protects from reading, copying, reproduction, replication, investigation, modification or any other form of revealing its content, as well as from deletion.

According to the invention, the software protection device can additionally comprise one or more co-processors, such as mathematical or cryptographic processor, or the like.

According to the invention, a method for protecting a software program from unauthorized use is provided, comprising the steps:

extracting at least one functional fragment of the said software program that prevents from correct execution of the remaining part of said software by a programmable computer device or makes the software execution impossible;

recording the said extracted functional software fragment into a non-volatile memory of a software protection device provided with means for protection of the said fragment from reading;

optionally, initiating additional protection of the functional fragment stored in the said non-volatile memory from copying, replication, investigation, modification and/or deletion;

embedding into the remaining part of the software application a transfer function for sending to the software protection device initial data and/or commands initiating execution of the extracted fragment to produce result data, and sending the result data to the programmable computer device.

In the present application, initial data comprises all the data required for correct execution of the extracted functional fragment of the software program.

The result data are data obtained as a result of execution of the extracted functional fragment of the software program.

In one embodiment, the step of applying read protection can be applied either before or after the said at least one functional fragment is recorded into the non-volatile memory. Once the protection is activated, the fragment cannot be read from the memory.

Optionally, the method further comprises a step of initiating additional protection of the functional fragment stored in the said non-volatile memory from copying, replication, investigation or modification or deletion. Thus, the protection can be activated step-wise, to provide different level of protection as required by the manufacturer.

For example, the method can further include a step of activating protection from writing/modification/deletion of a content, so once it is written into the memory, it cannot be further modified or deleted in any way and/or no any additional content cannot be written into the same non-volatile memory. This protection can be implemented, e.g. by password protection, or other appropriate means as can be defined by a specialist in the art.

According to another embodiment, a further step can be activated to protect from password screening. Available methods can be defined by a specialist in the art.

According to a still further embodiment, a final protection step can be activated to lock the memory completely.

According to the invention, the operation of the remaining part of the software in a programmable computer device together with the functional software fragment stored in the non-volatile memory of the software protection device becomes possible due to embedding corresponding functions, instructions or commands in the remaining part of the software. The embedded instructions or commands cause the programmable computer device to send initial data and/or commands to a software protection device such that, upon receipt of the initial data, the processor of the software protection device executes the functional software fragment or programs and produces the result data, which are sent back to the programmable computer device to enable subsequent execution of the remaining part of the software program on the programmable computer device.

It shall be appreciated that according to the invention the functional software fragment or program stored in the non-volatile memory of the software protection device is compiled to a code that can be executed by the processor of the software protection device or a code executable by another processor, e.g. using virtual machine emulation.

Optionally, upon storing in the non-volatile memory of the software protection device, the functional software fragment is debugged and any found errors are fixed. This is followed by activation of the content protection means for protecting from copying, replication, modification or deletion of the functional software fragments stored in the non-volatile memory of the software protection device.

According to the invention, a software program product kit for secure distribution of software is further provided, comprising a software program product lacking at least one functional fragment thereof; and a software protection device as described in detail above. The software program product can be downloaded from a network, or a remote server, or recorded on any suitable computer readable carrier, such as CD.

In another aspect of the invention, a software program distribution kit for secure distribution of software is provided, comprising a computer readable carrier having recorded thereon at least one software program lacking at least one functional fragment thereof; and a software protection device according to the invention.

In another aspect of the invention, a software program distribution kit for secure distribution of software is provided, comprising a software protection device storing both a software program lacking at least one functional fragment, and the said at least one functional fragment securely stored in the non-volatile memory of the software protection device.

In another aspect of the invention, a method for purchasing and securing software in a system comprising a customer computer, or any programmable computer device, a server, and a software protection device, is provided according to the invention, the method comprising the steps of purchasing or downloading software by a customer; installing said software on said customer programmable computer device, and running the software using the software protection device as described above.

In another aspect of the invention, a method of secure distribution of a software program using a software protection device is provided, comprising the steps of:

downloading the protected software program to a programmable computer device;

connecting the software protection device to the programmable computer device;

running the program on the programmable computer device, wherein, when the program reaches at least one transfer function embedded therein, it causes the programmable computer device to send initial data and/or commands to the software protection device,

receiving the initial data and executing the extracted software fragment on the software protection device to produce the result data,

transferring the result data to the programmable computer device to enable the execution of the subsequent part of the software program on the programmable computer device.

### BRIEF DESCRIPTION OF THE SEVERAL VIEWS OF THE DRAWING

The invention will be further described in more detail with reference to the drawings, where:

FIG. 1 is the functional block diagram illustrating a software protection device implemented in firmware according to one example embodiment of the invention.

FIG. 2 illustrates logical structure of a software program protected according to the invention.

FIG. 3 is a functional algorithm of a software protected according to the invention.

FIG. 4 illustrates the external appearance of a firmware means for protecting software, implemented in the form of a firmware module connectable via USB port to a Programmable Computer Device.

FIG. 5 is a circuit diagram of an example implementation of the embodiment of the invention in the form of a firmware module.

### DETAILED DESCRIPTION OF THE INVENTION

In the following detailed description of exemplary embodiments of the invention, reference is made to the drawings that illustrate specific exemplary embodiments in which the invention may be practiced. Those skilled in the art will appreciate that other embodiments may be utilized without departing from the spirit of the present invention; therefore the following detailed description of the invention should not be taken in a limiting sense.

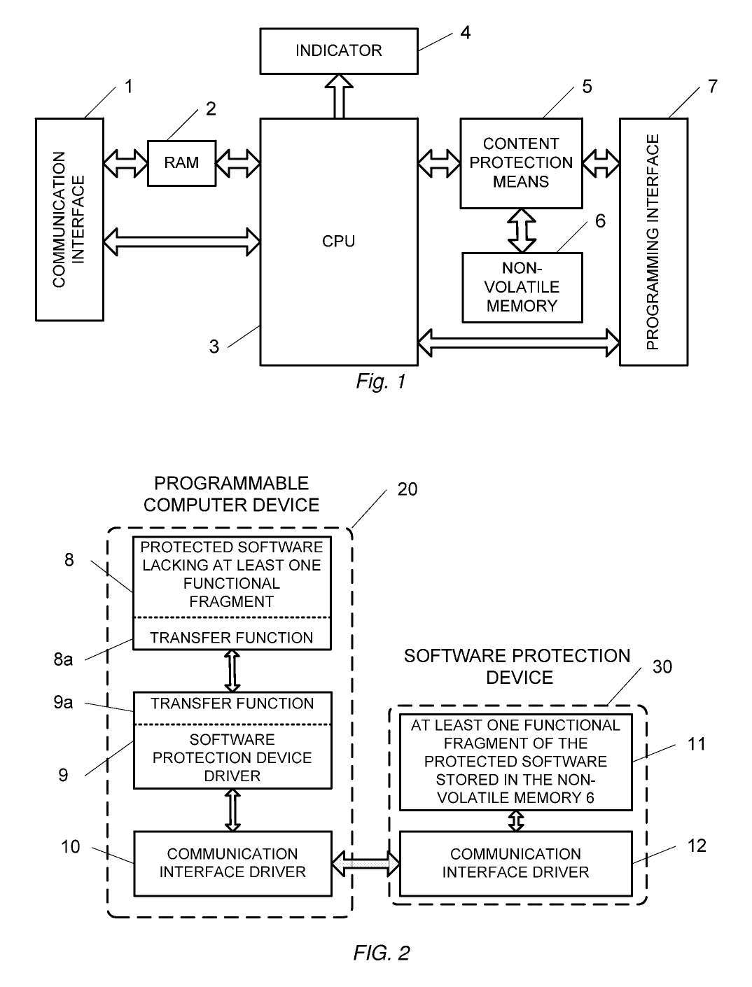

FIG. 1 is a diagram of an exemplary embodiment of the software protection device according to the invention, which comprises a processor, or central processing unit (CPU) 3, an RAM 2, a non-volatile memory 6, a content protection means 5, and an interface 1 to communication of the software protection device to a programmable computer device (not shown). There may be only one or a plurality of CPU 3, as there may optionally be only one or a plurality of RAM 2 or non-volatile memory 6. There may be only one or a plurality of interfaces 1; the invention is not so limited. The non-volatile memory 6 may be included in the CPU 3 or be separate from the CPU 3; generally, components or subcomponents of the software protection device may be combined with other components or subcomponents for higher integration and perhaps lower cost. For example, the above functional blocks can be implemented in hardware, e.g. as a plurality of separate devices interconnected by data links, or as a single device incorporating all the above mentioned blocks, such as an integrated circuit performing all the aforesaid functions, or some blocks can be combined while other packaged separately.

The programmable computer device or digital appliance used by an end user for some end use of one or more digital content files may be of any of several types of programmable computer devices, for example a PC, controller, laptop, tablet computer, PDA, or any other programmable computer devices that may be used with software.

The software protection device can further comprise an indicator 4 for indicating the status of any one of the subcomponents of the software protection device, or the mode or operation, e.g. unloaded or loaded status of the non-volatile memory, or programming mode or operating mode of the device.

Optionally, the software protection device can comprise a programming interface 7 for programming the said non-volatile programmable memory.

The above components are interconnected by a communication interface or data exchange link.

The interface 1 can be implemented to connect the software protection device with a programmable computer device or digital appliance in both physical- and communication aspects.

The physical aspect can be, for example directly, through one or more cables, and/or ports or buses.

The communication aspect of the interface 1 allows data exchange between the software protection device and the digital appliance via wireless, IR or any other suitable means. The interface 1 may be any of several types of interfaces, for example PCI, ISA, Universal Serial Bus (USB), FireWire, IDE, SCSI, RS-232 or other serial interface, parallel interface, Compact Flash (CF) interface, Sony Memory Stick interface, Multimedia Card (MMC), secure digital (SD), mini secure digital, extreme digital (xD), Bluetooth, Infiniband, mobile phone interface, PDA interface, and/or any other type of interface that may be used to connect a software protection device with a digital appliance, such as a programmable computer device.

Further, the interface 1 can be used for transferring initial data and/or commands to software protection device and receiving the result data from the software protection device.

In an alternative embodiment, communication interface 1 can be integrated with the programming interface 7. In this case, interface 1 can also be used for loading the code to the memory 6.

A random access memory (RAM) 2 stores variables, stack data and buffer functionality for exchanging data or other information required for the operation of CPU 3, optional indicator or display device 4, communication interface 1, memory content protection means 5, non-volatile memory 6 and programming interface 7.

The CPU 3 executes the code contained in the functional computer program fragment stored in the memory 6. The CPU 3 may be a general purpose CPU or a CPU with dedicated functions. The CPU 3, the non-volatile memory 6, and/or other components may be implemented as an optionally tamper resistant hardware, or sections of the CPU 3, the non-volatile storage 6, and/or other components may be tamper resistant; the invention is not so limited.

The optional display device or indicator 4 provides visual information if necessary.

The non-volatile memory 6 contains the functional software fragment in the form of a machine code executable by the CPU 3, or in the form of a code executable by another processor using emulation technique. The non-volatile storage 6 may also store some other data, such as a plurality of methods for authentication; the invention is not so limited.

The non-volatile memory 6 may be any of several types of storage including semiconductor based media such as read only memory (ROM), electronic erasable programmable read only memory (EEPROM), flash memory or battery backed up random access memory (RAM), or other types of non-volatile storage, including reprogrammable memory, non-reprogrammable memory, bidirectional electrically programmable integrated memory and the like, this invention is not so limited.

The content protection means 5 allow the CPU 3 to execute the code contained in the software fragment stored in the non-volatile memory 6, but prevent direct access to the data stored in the non-volatile storage 6. The content protection means excludes user access to the content of the non-volatile memory storing the at least one functional fragment of the software protected according to the invention. The programming interface 7 can be used for initial programming of the non-volatile storage 6 and can also be used by developers for loading the code of the functional computer programs fragment, programs and data to the non-volatile memory 6 and subsequent activation of the protection means 5 or, if necessary, for deletion or unrecoverable destruction of the data stored in the non-volatile memory 6. Alternatively, programming interface 7 can be integrated with the communication interface 1 at the hardware level. In one example embodiment, a software protection device can be implemented in the form of an external firmware module comprising microchip AT91SAM7S128, non-volatile flash memory with capacity of 128 kB, a wireless communication interface for data communication with a laptop, the ARM7 32-digit processor of 55 MFLOPS and SRAM with capacity of 16 kB.

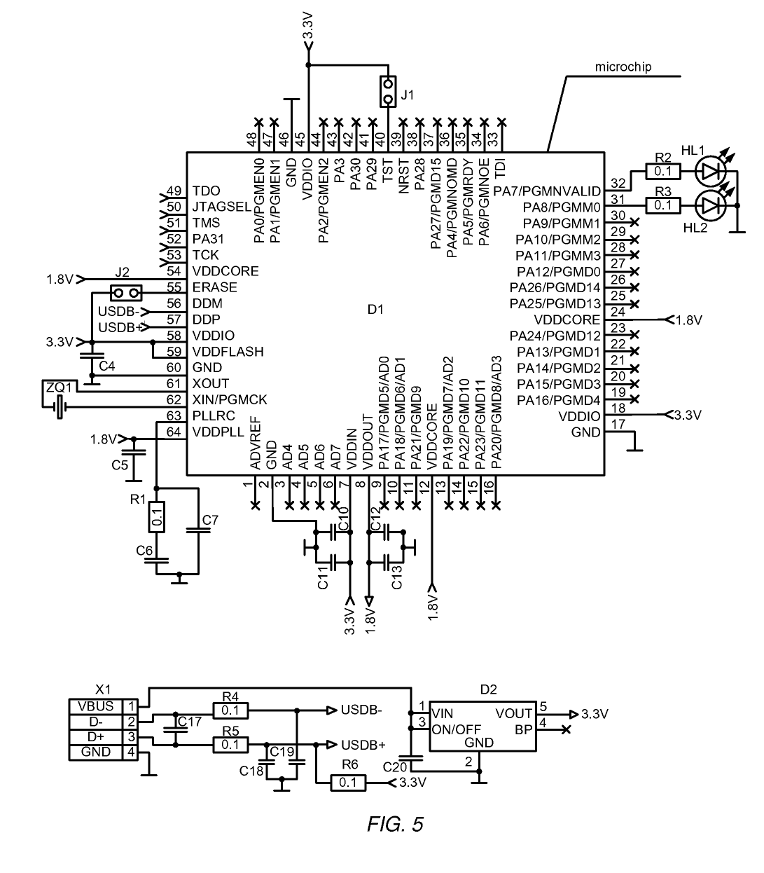

In another example embodiment, a software protection device according to the invention is implemented in the form of an external firmware module, comprising microchip AT91SAM7S256, non-volatile flash memory with capacity of 256 kB, a USB communication interface for data communication with a PC, the ARM7 32-digit processor of 55 MFLOPS and SRAM with capacity of 32 kB, such as illustrated in FIG. 5.

In still another embodiment, the software protection device according to the invention is implemented in the form of an internal PC circuit board with a programmable microchip AT91SAM7S512, non-volatile flash memory with capacity of 512 kB, the ARM7 32-digit processor of 55 MFLOPS and SRAM with capacity of 64 kB.

FIG. 2 is a block diagram illustrating the logic structure of a non-limiting example embodiment of a software program product protected according to the invention, having one part (software modules 8, 9, 10) residing in a programmable computer device 20 and another part (software modules 11, 12) securely stored in a software protection device 30 according to the invention.

As shown in FIG. 2, the first part of the software program product according to the invention to be executed on a programmable computer device 20 includes module 8 comprising a software having extracted therefrom at least one functional fragment, the first part comprises a data transfer function 8a embedded therein, module 9 being a driver embedding a matching data transfer function 9a for transferring initial data and/or commands as described in detail above, and module 10 being a communication interface driver for communicating data to the software protection device 30. The first part can further include any additional supporting or functional components, if desired. These components can be created by a specialist in the art using any available programming tools.

The second part is securely stored in a separate software protection device 30 thereby keeping said second part away from said programmable computer device 20. The second part includes module 11 comprising the said at least one functional fragment extracted from the first part and stored securely in the read-proof non-volatile memory of the said software protection device and module 12 comprising a communication interface for communication with the programmable computer device 20.

While modules 8 and 11 are main functional components of the protected software program, modules 9, 10, 12 are secondary modules comprising drivers supporting the functioning of the main components. The suitable supporting drivers can be easily compiled by a specialist in the art and are not the subject of the present invention.

According to the invention, during execution of the first part of the program in the programmable computer device 20, the said at least one data transfer function 9a incorporated into driver 9, provides correct transfer of initial data via driver 10 to the software protection device 30, enabling separate execution of the second part in software protection device 30, to produce result output data that are respectively transferred back via driver 12 to the programmable computer device 20 to enable subsequent execution of the first part in the computer device 20.

It shall be appreciated that the transfer function can be implemented as at least one single sending or receiving module, at least one single module including both sending/receiving functions, or as several modules including modules of any of these types.

These transfer functions can be incorporated both in place of the extracted fragment as well as into any other place or section of the program as required for the program operation, for example, in accordance with the demands for result data from the software protection device and can be easily defined by a specialist in the art.

According to the invention, the first part comprises at least one foregoing portion to be executed before the extracted functional fragment, at least one transfer function, and at least one subsequent portion to be executed upon receipt of the result data obtained by executing the extracted fragment on a separate software protection device. There could be two or more functional modules extracted from the first part, if desired, and independently, there could be one or more transfer functions or transfer function modules embedded into the first part.

### Detailed Description of a Method of Protecting a Software Program

Unlike other known software protection methods relying on storage of separate fragments (i.e. software and computer program modules, passwords and activation codes) in the memory of a software protection device, according to the present invention, the functional software fragments or programs stored in non-volatile memory 6 cannot be read directly via data links and as a result cannot be copied to a programmable computer device memory or any media for further unauthorized use, but are executable by CPU 3.

This means that even if CPU 3 is in communication with the programmable computer device, it is still impossible to replicate a complete software version including all the functional fragments or programs required for normal operating.

A method of software protection using a software protection device according to the invention can be implemented as follows.

According to the first step of the method, at least one functional fragment or a software is selected that will be made unavailable for reading, replication, copying, deletion or/and modification.

Further, according to a second step of the method, the selected at least one functional software fragment or program is extracted from the software (if this is a commercial ready-to-use product).

In another embodiment, if the program is still in the process of its compilation, a programmer compiles it in a way so as to consist of separate modules, such that each one separately is not sufficient for end use of the software program.

Then, on the third step, the selected fragment (module) is compiled to a machine code, which is executable by CPU 3. Alternatively, the selected fragment (module) can be compiled to a code of another processor, which can be executed using virtual machine emulation.

According to a forth step, the remaining part of the software is then provided with at least one embedded transfer function for communicating with the extracted part and compiled into the programmable computer device processor code, such that, when the software program reaches the said at least one transfer function, this causes the programmable computer device to transfer to the software protection device initial data and/or commands required to process the extracted part of the software program stored in the non-volatile memory of the software protection device.

It shall be appreciated that the CPU 3 shall be respectively provided with instructions and/or commands such that, upon receipt of the initial data from the programmable computer device, the CPU executes the extracted software fragment stored in the non-volatile memory to produce result data, which are sent back to the programmable computer device.

Then, in the fifth step, the software protection device is connected to the programmable computer device or other programming device via the communication interface 1, or any other communication interface 1, or programming interface 7. The connection can be made either via data port, a bus, or by wireless connection, as described above. Any other available means providing bidirectional transfer of data and/or commands from a programmable computer device to the software protection device can be used according to the invention, such as IR port of the mobile phone, palm PC, etc. The compiled modules of the at least one functional software fragment or program are loaded into non-volatile storage 6 of the software protection device. These modules are stored in the part of the non-volatile memory 6 inaccessible by software users and can be executed only directly in the software protection device by CPU 3.

Optionally, once the functional software fragment or program is uploaded to non-volatile memory 6, the next step is debugging that is typically run in order to fix the errors found in the software.

If any errors are found in the functional software fragment or a program stored in non-volatile memory 6 during debugging, they are properly fixed. The functional software fragment or programs are then recompiled and uploaded again to non-volatile memory 6.

Optionally, according to the sixth step, upon debugging, the content protection device 5 is activated using known methods, whereupon the said at least one functional software fragment or program stored in secure form in non-volatile memory 6 of the software protection device cannot be read, replicated or otherwise reproduced using known methods of intrusion.

It shall be appreciated that the said at least one functional fragment is stored in the form of a machine code executable by CPU 3 only, while, when the remaining part executed by a programmable computer device reaches the embedded at least one transfer function, this causes the programmable computer device to send initial data and/or commands to the software protection device while continuing execution of other functions of the protected software. The software protection device, upon receipt of the initial data, produces result data obtained upon execution of the extracted functional software fragment in the CPU 3 of the software protection device and sends these data to the computer. This eliminates the necessity of sending the fragment or program in open form to a programmable computer device via data links.

Thus, as a result, each copy of a distributed software protected according to the invention lacks at least one functional software fragment or program, wherein the lacking fragment is securely stored in the non-volatile memory 6 of a software protection device according to the invention.

Thus, in another aspect of the invention, a protected software program product is provided having a functional fragment or programs extracted from this software product and securely stored in the software protection device. In the absence of the software protection device the software will be inoperable and, therefore, useless for any unauthorized purpose.

This provides an easy tool for manufactures of copyrighted software to make software resistant to hacker's attacks. The use of software protected according to the present invention is possible only in conjunction with the use of the software protection device (e.g. a firmware module shown on FIG. 4) in addition to the software copy downloaded from the network or recorded on a media device.

The software protection device shall be connected to the programmable computer device or a programmable computer device prior to use the software, otherwise the software would bring up a message informing of the failure to detect the software protection device and deny further access.

Any attempt to intercept or block the functions of detection and correct operation of the software protection device via communication interface or any other possible data links would result in software execution up to the point of transferring data to the software protection device causing a system error. Thus, the software will not be able to perform normally, while the unauthorized user will receive a respective message.

Any attempt to block transfer of initial data and/or commands to the software protection device and receipt of result data from the software protection device, such as overriding these functions and forcing the software to execute, would result in incorrect operation that can also be displayed in a message to any unauthorized user.

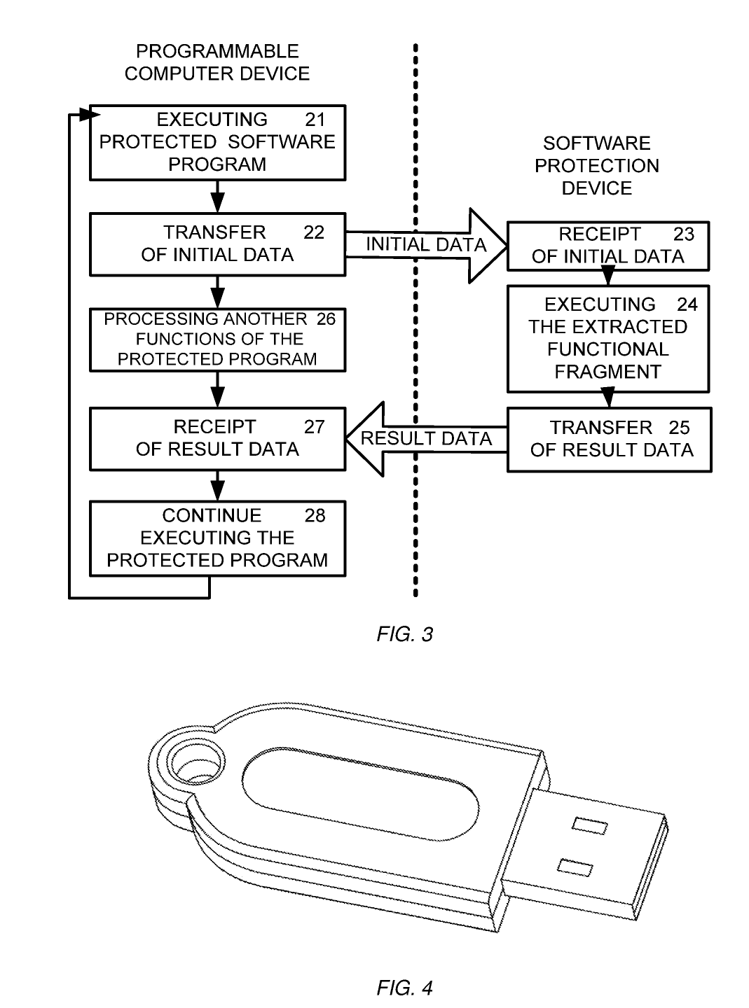

FIG. 3 illustrates execution of a software program product protected using a software protection device according to the invention in a user computer or other programmable computer device, such as a controller, PC, laptop or the like.

As shown on FIG. 3, the programmable computer device 20 executes step 21 of processing the first part of the software program residing in the programmable computer device memory, and other optional programs, if required.

Instead of execution of the extracted functional fragment in the programmable computer device, initial data and/or commands are sent in step 22 to the CPU 3 of the software protection device via the communication interface 1.

According to step 23, upon receipt of the initial data and/or commands, CPU 3 in step 24 executes the functional software fragment stored in the non-volatile storage 6 and in step 25 sends the computation results back to the programmable computer device via the communication interface (step 27) to enable step 28 of subsequent execution of the remaining part of the software on the programmable computer device.

Optionally, in parallel to execution of step 24 in the software protection device, a programmable computer device can execute other functions, fragments of the protected software in step 26.

Thus, the said a least one functional software fragment or program securely stored in the non-volatile memory 6 can be executed by CPU 3 but cannot be read or copied directly from the non-volatile memory 6 when running the software.

According to the invention, one or more functional software fragments or one or more programs can be extracted from the software and stored in secure form in non-volatile storage 6, if necessary.

FIG. 4 shows a specific example embodiment of the software protection device implemented as an external USB device.

The method and device for software protection according to the invention provides powerful tools for protection of copyright and intellectual property rights of developers of software from unauthorized use, replication, distribution and investigation.

The proposed method and device for software protection prevent a programmable computer device user from accessing the functionally significant part of the software even while running the software on the programmable computer device thus excluding the possibility of creation and use of illegal copies.

This is achieved by preventing physical access to at least one functionally significant part of the software, which is extracted from the commercially distributed product. Moreover, this functionally significant part of the software is always unavailable to the programmable computer device processor and the user, and, therefore, cannot be neither executed by the programmable computer device processor, recorded into the programmable computer device memory or via communication interface nor copied to any media or otherwise modified even by using special tools or software.

The extracted functional fragment of the software is executed within the software protection device upon receipt of the initial data and/or commands from the programmable computer device, while the results of execution of the extracted functional fragment processed by the CPU 3 of the software protection device are sent back to the programmable computer device, and not the fragment itself.

According to another specific embodiment, the software program enclosed within the software protection device is a cryptographic program, wherein the said at least one functional fragment is the cryptographic algorithm itself.

In one example embodiment, encryption/decryption keys are generated within the software protection device using a program for generating cryptographic keys, wherein both the program and generated keys are securely stored in the protected part of the non-volatile memory of the software protection device.

Alternatively, the encryption/decryption keys can be generated by any other programmable computer device and subsequently recorded and securely stored within the said software protection device.

In this case, information is encrypted/decrypted within the software protection device using the cryptographic key and cryptographic program both being stored and secured therein. Distribution of software programs protected according to the invention involves shipping software protection devices implemented, e.g. as a firmware module (see FIG. 4) or otherwise (e.g. as an internal PEC card) with each copy of the software.

Such devices are well-suited for implementing the proposed method of software protection due to integration of the non-volatile memory hosting the functional software fragment, the CPU to execute the functionally significant part of the protected software and the means of protection within one and the same microchip thus denying physical access from outside to the data links between the processor core and the non-volatile memory.

Those skilled in the art will appreciate that the invention can be implemented by other forms and ways, without departing from the spirit of the invention. The embodiments described herein shall be considered as illustrative only and does not restrictive the invention by no means.

We claim:

1. A software protection device for protecting a software program from unauthorized use, comprising:
a non-volatile memory for recording and storing at least one functional fragment extracted from the said software program,
a content protection means for protecting at least part of the content of the said non-volatile memory, the protected part storing the said at least one functional fragment extracted from the said software program;
a communication interface for data communication with a programmable computer device, and
a processor for processing the extracted functional software fragment stored in the said non-volatile memory;
wherein the said software protection device is connectable to a programmable computer device for communicating data to enable execution of the remaining part of the software program.

2. The software protection device of claim 1, wherein the said at least one functional fragment is stored in the said non-volatile memory in the form of a code executable by the processor of the software protection device.

3. The software protection device of claim 1, wherein the said at least one functional fragment is stored in the said non-volatile memory in the form of a code of another processor, which can be executed using virtual machine emulation.

4. The software protection device of claim 1, which is implemented in the form of an external device or internal programmable computer device module.

5. The software protection device of claim 1, which is implemented in the form of a firmware module, a circuit board, a circuit board with a programmable microchip, programmable controller or programmable logic device.

6. The software protection device of claim 1, wherein the said communication interface is adapted for connecting the software protection device to the programmable computer device via physical connection means, including but not limited to, cables, computer ports or buses.

7. The software protection device of claim 1, wherein the said communication interface is adapted for connecting the software protection device to the programmable computer device via communication media, e.g. wireless or any other type of communication media.

8. The software protection device of claim 1, wherein the said data communication comprises sending initial data and/or commands from a programmable computer device to initiate execution of the extracted fragment in the software protection device to produce result data, and sending the result data to the said programmable computer device.

9. The software protection device of claim 1, wherein the said non-volatile memory is selected from the group including but not limited to a non-volatile programmable memory, programmable flash memory, EEPROM, reprogrammable memory, non-reprogrammable memory, bidirectional electrically programmable integrated memory and the like.

10. The software protection device of claim 1, wherein the said content protection means protects from at least one of reading, copying, replication, investigation, modification, any other form of revealing its content and/or deletion.

11. The software protection device of claim 1, wherein the said content protection means is multilevel.

12. The software protection device of claim 1, wherein the said content protection means provides a read-proof protection, so that any content can be recorded into the memory but once written, cannot be read out.

13. The software protection device of claim 12, wherein the said content protection means further provides write/modification/deletion protection, so that once the content is written into the memory, it cannot be further modified in any way.

14. The software protection device of claim 13, wherein the said write/modification/deletion protection is achieved by password protection, which can be optionally further enhanced by including additional protection from password screening.

15. The software protection device of any one of claims 9 to 14, wherein the said content protection means is implemented in hardware, software or firmware.

16. The software protection device of claim 1 further comprising an additional interface for programming the said non-volatile programmable memory.

17. The software protection device of claim 16 wherein the said additional programming interface is integrated with the communication interface, or connected with the non-volatile memory via a data link.

18. The software protection device of claim 16 or 17, wherein the said content protection means at least partially or completely blocks access to the non-volatile memory via the programming interface and/or processor.

19. The software protection device of claim 16 or 17, wherein the said content protection means switches off the programming interface.

20. The software protection device of claim 1 further comprising a random-access memory for performing at least one function of: storing variables, stack data, providing a data exchange buffer, information exchange, or the like as required for processor operation.

21. The software protection device of claim 1, wherein the remaining part of the software program lacking at least one functional fragment is stored in the part of the non-volatile memory which is not necessarily protected by content protection means.

22. The software protection device of claim 1, further comprising additional non-volatile memory for storing the remaining part of the software program lacking at least one functional fragment.

23. The software protection device of claim 1, further comprising an indicator for indicating the status or operation mode of at least one or each of the following components: a processor, non-volatile memory, content protection means for protecting the content of the said non-volatile memory, and communication interface.

24. The software protection device of claim 1, adapted for protecting a software program which is distributed from a remote server.

25. The software protection device of claim 1, for protecting a software program which is distributed in the form recorded and stored on a computer readable media, such as a CD, or flash memory, or the like.

26. The software protection device of claim 1, wherein the software program is a cryptographic program, the said at least one functional fragment being the cryptographic algorithm.

27. A software protection device for protecting a software program from unauthorized use, comprising:
a non-volatile memory for recording and storing at least one functional fragment extracted from the said software program;
an optional storage for recording and storing the remaining part of the said software program having at least one transfer function embedded therein for sending to the software protection device initial data and/or commands initiating execution of the extracted fragment to produce result data, and sending the result data to the programmable computer device;
a content protection means for protecting at least part of the content of the said non-volatile memory, wherein the content protected part stores the said at least one extracted functional fragment;
a communication interface for communicating data with a programmable computer device,
a processor for processing, upon receipt of said initial data and/or commands, the extracted functional software fragment stored in the said non-volatile memory to produce the result output data;
wherein the result data are sent to said programmable computer device via the communication interface to enable the execution of the remaining part of the protected software program by the said programmable computer device.

28. A method for protecting a software program from unauthorized use, comprising the steps of:
extracting at least one functional fragment of the said software program that prevents from correct execution of the remaining part of the said software program by a programmable computer device or makes execution of the software impossible;
recording the said extracted functional software fragment into a non-volatile memory of a software protection device provided with content protection means;
embedding into the remaining part of the software a transfer function for sending to the software protection device initial data and/or commands initiating execution of the extracted fragment to produce result data, and sending the result data to the programmable computer device.

29. The method of software protection of claim 28, wherein the means for content protection of said non-volatile memory is initiated prior or after the step of recording the said at least one functional fragment into the said non-volatile memory.

30. The method of software protection of claim 28, wherein the step of content protection provides protection from reading, so that any content can be recorded into the memory but once written, cannot be read out.

31. The method of software protection of claim 29, further comprising at least one protective step selected from protection from writing, copying, replication, investigation, modification and/or deletion.

32. The method of software protection of claim 31, wherein the step of write/modification/deletion protection is performed by password protection, further optionally including a step of protecting from password screening.

33. The method of claim 28 wherein the functional software fragment is recorded and stored in the non-volatile memory in the form of a code executable by the processor of the software protection device or another processor using virtual machine emulation.

34. The method of claim 28 further including a step of debugging the said software program and fixing the detected errors prior to initiating the content protection means.

35. A method of protecting a software program, comprising the steps of:
executing a part of the software program lacking at least one functional fragment, on a programmable computer device; and
executing the extracted functional software fragment on the software protection device.

36. The method of claim 35 wherein the software protection device is the device as claimed in any one of claims 1 to 27.

37. A software program product, comprising:
a first part, to be executed on a programmable computer device, wherein the first part lacks at least one functional fragment extracted therefrom and comprises at least one data transfer function; and
a second part, to be executed on a separate software protection device, thereby keeping said second part away from said programmable computer device; wherein the second part comprises the said at least one functional fragment extracted from the first part and stored securely in a content protected non-volatile memory of the said software protection device.

38. A software program product of claim 37, wherein the said at least one data transfer function, upon initialing execution of the first part of the program, transfers initial data and/or commands to the said software protection device enabling separate execution of the second part in said software protection device to produce result data that are transferred back to the programmable computer device to enable subsequent execution of the first part.

39. A software program product of claim 37, wherein the first part comprises at least one foregoing portion to be executed before the extracted functional fragment, at least one transfer function, and at least one subsequent portion to be executed upon receipt of the result output data obtained by executing the extracted fragment on a separate software protection device.

40. A software program product of claim 37, wherein the extracted functional fragment is stored in the form of a processor code executable on a software protection device or in the form of a code of another processor, which can be executed using virtual machine emulation.

41. A software program product produced by a method as claimed in any one of claims 28 to 36.

42. A software program product kit for secure distribution of software, comprising a software program product lacking at least one functional fragment thereof; and a software protection device as claimed in any one of claims 1 to 27, securely storing the said extracted at least one functional fragment.

43. A software program product of claim 42, wherein the software program is selected from the software downloadable from a network, a remote server, recorded on a computer readable carrier, or in a software protection device.

44. A software program distribution kit for secure distribution of software, comprising:
a computer readable carrier having recorded thereon at least one software program lacking at least one functional fragment thereof; and
a software protection device as claimed in any one of claims 1 to 27, securely storing the said extracted at least one functional fragment.

45. A method of secure distribution of a software program using a software protection device as claimed in any one of claims 1 to 27, comprising the following steps:
downloading a protected software program lacking at least one functional fragment, on a programmable computer device;
purchasing the software protection device and connecting to the programmable computer device;
running the program on the programmable computer device.

46. A computer program product comprising program code instructions such that when executed on a computer it performs the steps of the method according to any one of claims 28 to 36.
